(19) United States
(12) Patent Application Publication
(10) Pub. No.: US 2026/0141678 A1
(43) Pub. Date: May 21, 2026

(54) METHOD OF CLUSTERING LIDAR POINT CLOUDS IN RANGE IMAGE AND COMPUTING DEVICE

(71) Applicant: VUERON TECHNOLOGY CO., LTD., Seoul (KR)

(72) Inventors: Jae Wook HWANG, Seoul (KR); Jae Kwang KIM, Bucheon-si (KR)

(73) Assignee: VUERON TECHNOLOGY CO., LTD., Seoul (KR)

(21) Appl. No.: 19/381,535

(22) Filed: Nov. 6, 2025

(30) Foreign Application Priority Data
Nov. 20, 2024 (KR) 10-2024-0166358

(51) Int. Cl. G06V 10/762

(52) U.S. Cl. CPC G06V 10/7635

(57) ABSTRACT

Provided are a computing device and a method of clustering lidar point clouds in a range image performed by a processor. The method includes selecting a first lidar point included in a first cell among a plurality of cells in a range image partitioned the plurality of cells and selecting lidar points in the first cell to determine whether the lidar points are included in the same cluster as the first lidar point.

### CROSS-REFERENCE TO RELATED APPLICATION

This application claims priority to and the benefit of Korean Patent Application No. 2024-0166358, filed on Nov. 20, 2024, the disclosure of which is incorporated herein by reference in its entirety.

### BACKGROUND

### 1. Field of the Invention

The present invention relates to a method and device for clustering lidar point clouds in a range image, and more particularly, to a method and device for clustering lidar point clouds in a range image with irregular angular resolution.

### 2. Discussion of Related Art

A range image is generated by projecting three-dimensional (3D) lidar point cloud data generated by a lidar sensor onto a two-dimensional (2D) grid. A range image is a 2D image, in which each pixel represents the distance from the lidar sensor to a specific lidar point in the environment.

There are several types of lidar sensors for generating 3D lidar point clouds. A spinning lidar refers to a sensor that uses a rotating assembly to emit laser pulses from a 360-degree field of view. A solid-state lidar has no moving parts and utilizes an electronic mechanism. For example, a solid-state lidar may be flash lidar, a micro-electro-mechanical systems (MEMS) lidar, or an optical phased array (OPA) lidar.

A clustering method in a range image according to the related art is applicable to only range images generated on the basis of a single spinning lidar. The clustering method in a range image according to the related art is inapplicable to range images generated on the basis of a solid-state lidar. In addition, the clustering method in a range image according to the related art is also inapplicable to range images generated on the basis of two or more spinning lidars.

Therefore, a new clustering method in a range images is necessary that is applicable to range images generated on the basis of a solid-state lidar or two or more spinning lidars.

### SUMMARY OF THE INVENTION

The present invention is directed to providing a method and device for clustering lidar point clouds in a range image with irregular angular resolution.

According to an aspect of the present invention, there is provided a method of clustering lidar point clouds in a range image performed by a processor, the method including selecting a first lidar point included in a first cell among a plurality of cells in a range image partitioned into the plurality of cells and selecting lidar points in the first cell to determine whether the lidar points are included in the same cluster as the first lidar point.

The method of clustering lidar point clouds in a range image may further include selecting a second lidar point among lidar points with a smallest phi value in the first cell, selecting a third lidar point among lidar points with a largest phi value in a second cell adjacent to the first cell, and determining whether the second lidar point and the third lidar point are included in the same cluster.

The method of clustering lidar point clouds in a range image may further include selecting a fourth lidar point among lidar points with a largest theta value in the first cell, selecting a fifth lidar point among lidar points with a smallest theta value in a third cell adjacent to the first cell, and determining whether the fourth lidar point and the fifth lidar point are included in the same cluster.

The selecting of the lidar points in the first cell to determine whether the lidar points are included in the same cluster as the first lidar point may include determining the selected lidar points in accordance with phi value differences and theta value differences calculated between lidar points included in the first cell and the first lidar point.

The selected lidar points may include a lidar point with a smallest one of phi value differences calculated between lidar points included in the first cell and the first lidar point and a lidar point with a smallest one of theta value differences calculated between the lidar points included in the first cell and the first lidar point.

According to another aspect of the present invention, there is provided a computing device including a processor configured to execute instructions to cluster lidar point clouds in a range image and a memory configured to store the instructions.

The instructions are implemented to perform the operations of selecting a first lidar point included in a first cell among a plurality of cells in a range image partitioned into the plurality of cells and selecting lidar points in the first cell to determine whether the lidar points are included in the same cluster as the first lidar point.

The instructions may be implemented to further perform the operations of selecting a second lidar point among lidar points with a smallest phi value in the first cell, selecting a third lidar point among lidar points with a largest phi value in a second cell adjacent to the first cell, and determining whether the second lidar point and the third lidar point are included in the same cluster.

The instructions may be implemented to further perform the operations of selecting a fourth lidar point among lidar points with a largest theta value in the first cell, selecting a fifth lidar point among lidar points with a smallest theta value in a third cell adjacent to the first cell, and determining whether the fourth lidar point and the fifth lidar point are included in the same cluster.

The instructions implemented to perform the operation of selecting the lidar points may be implemented to select the lidar points in accordance with phi value differences and theta value differences calculated between lidar points included in the first cell and the first lidar point.

The selected lidar points may include a lidar point with a smallest one of phi value differences calculated between lidar points included in the first cell and the first lidar point and a lidar point with a smallest one of theta value differences calculated between the lidar points included in the first cell and the first lidar point.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram of a system for clustering lidar point clouds in a range image according to an exemplary embodiment of the present invention;

FIG. 2 is a conceptual diagram illustrating an operation of generating a range image using a spinning lidar;

FIGS. 3A and 3B are a set of a three-dimensional (3D) point cloud image and a range image;

FIG. 4 is a conceptual diagram for determining whether lidar points included in a range image belong to the same cluster;

FIG. 5 is a conceptual diagram illustrating an operation of generating a range image using a solid-state lidar;

FIGS. 6 and 7 are range images illustrating a method of clustering lidar point clouds in a range image according to the present invention;

FIG. 8 is a range image illustrating a method of clustering lidar point clouds in a range image according to the present invention;

FIG. 9 is a flowchart illustrating a method of clustering lidar point clouds in a range image according to an exemplary embodiment of the present invention; and

FIGS. 10A and 10B are a set of range images acquired using a method of clustering lidar point clouds in a range image according to an exemplary embodiment of the present invention.

### DETAILED DESCRIPTION OF EXEMPLARY EMBODIMENTS

Specific structural or functional descriptions merely exemplify embodiments according to the concept of the present invention disclosed in the present specification, and embodiments according to the concept of the present invention may be implemented in various forms and are not limited to the embodiments described herein.

Since the embodiments according to the concept of the present invention are subject to various modifications and may take a variety of forms, embodiments are illustrated in the drawings and described in detail in the present specification. However, this is not intended to limit the embodiments according to the concept of the present invention to any disclosed form, and is to be understood to include all modifications, equivalents, or substitutions that fall within the spirit and technical scope of the present invention.

Terms such as “first,” “second,” etc., may be used to describe various components, but the components are not limited by the terms. The above terms are used solely for the purpose of distinguishing one component from another. For example, without departing from the scope of rights according to the concept of the present invention, a first component may be named a second component, and similarly a second component may be named a first component.

When a component is referred to as “coupled” or “connected” to another component, it should be understood that the component may be directly coupled or connected to the other component or there may be still another component therebetween. On the other hand, when a component is referred to as “directly coupled” or “directly connected” to another component, it should be understood that there is no other component therebetween. Other expressions describing the relationship between components, such as “between” and “directly between,” “adjacent to” and “directly adjacent to,” etc., should be construed similarly.

Terminology used herein is intended to describe particular embodiments only and is not intended to limit the present invention. Singular expressions include plural expressions unless context clearly indicates otherwise. As used herein, terms such as “include,” “have,” etc., are intended to designate the presence of described features, numbers, steps, operations, components, parts, or combinations thereof, and are not intended to preclude the presence or addition of one or more other features, numbers, steps, operations, components, parts, or combinations thereof.

Unless otherwise defined, all terms used herein, including technical or scientific terms, have the same meaning as commonly understood by those of ordinary skill in the technical field to which the present invention pertains. Terms such as those defined in commonly used dictionaries should be construed as having meanings consistent with their meaning in the context of the relevant art and should not be construed as having an idealized or unduly formal meaning unless expressly defined in the present specification.

Hereinafter, the present invention will be described in detail by describing exemplary embodiments of the present invention with reference to the accompanying drawings.

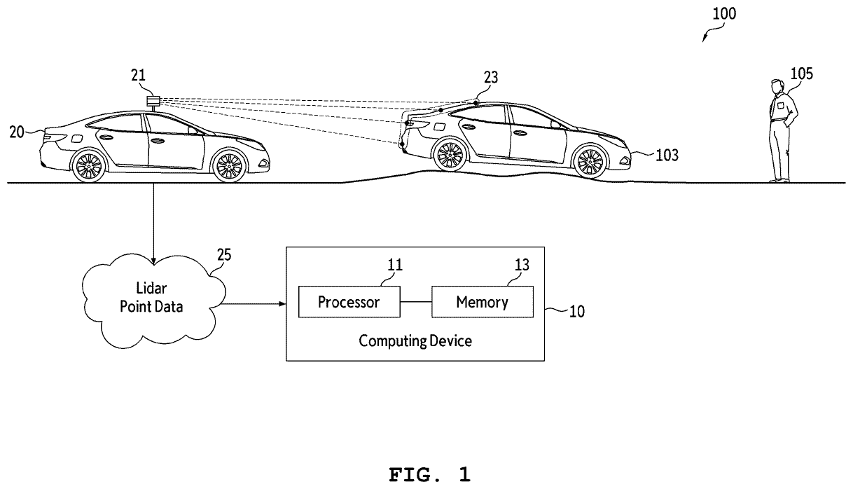

FIG. 1 is a block diagram of a system for clustering lidar point clouds in a range image according to an exemplary embodiment of the present invention.

Referring to FIG. 1, a system 100 is a system that may cluster lidar point clouds in a range image. Clustering is an operation of determining whether lidar point clouds belong to the same cluster, segment, or group.

The system 100 includes a lidar sensor 21 and a computing device 10.

The lidar sensor 21 may be installed on a moving vehicle 20 or a fixed infrastructure such as a pole or tower. The lidar sensor 21 generates a three-dimensional (3D) point cloud 25 by emitting laser light toward objects (e.g., a vehicle 103 or a person 105) in an environment. The 3D point cloud 25 includes a lidar point set. The lidar point set may be referred to as “lidar point data 25.” The lidar point set includes a plurality of lidar points. In FIG. 1, the reference number “23” indicates one lidar point. The single lidar point 23 may be expressed as 3D coordinates (x, y, z). In the present specification, lidar points, lidar point data, a 3D point cloud, and a lidar point cloud may all be understood as the same concept. The lidar sensor 21 is two or more spinning lidars or a solid-state lidar.

The computing device 10 may be implemented as a hardware module that is combined with other hardware in the vehicle 20, or an independent hardware device. For example, the computing device 10 may be implemented in an electronic control unit (ECU) of the vehicle 20. Also, the computing device 10 may be implemented as an external electronic device such as a computer, a laptop, a personal computer (PC), a server, a tablet PC, or the like.

The computing device 10 includes a processor 11 and a memory 13. The processor 11 executes instructions to cluster lidar point clouds in a range image. The memory 13 stores the instructions.

The processor 11 receives the 3D point cloud 25 from the lidar sensor 21. Each of lidar points included in the 3D point cloud 25 may be expressed as 3D coordinates (x, y, z).

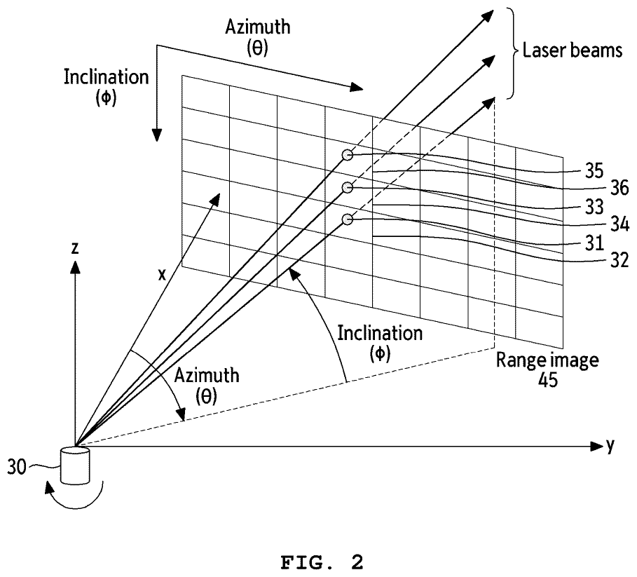

FIG. 2 is a conceptual diagram illustrating an operation of generating a range image using a spinning lidar.

Referring to FIGS. 1 and 2, when the lidar sensor 21 shown in FIG. 1 is a spinning lidar 30, the processor 11 transforms each of lidar points (e.g., 31, 33, and 35) expressed as 3D coordinates (x, y, z) from Cartesian coordinates into spherical coordinates. The spherical coordinates are expressed as 3D coordinates (r, θ, φ).

r represents a range, θ represents an azimuth angle, and φ represents an elevation angle. The elevation angle φ is an inclination angle.

The range r is calculated as shown in equation 1 below.

$$r = \sqrt{( {x}^{2} + {y}^{2} + {z}^{2}} \qquad [ Expression 1 ]$$

x, y, and z are Cartesian coordinates.

The azimuth angle θ is calculated as shown in equation 2 below.

$$θ = arctan ( \frac{x}{y} ) \qquad [ Equation 2 ]$$

The elevation angle φ is calculated as shown in equation 3 below.

$$Φ = arcsin ( \frac{z}{r} ) \qquad [ Equation 3 ]$$

The processor 11 generates a range image 45 in accordance with the angular resolution of the lidar sensor 21. The range image 45 is partitioned into a plurality of cells. In other words, the range image 45 is divided into a two-dimensional (2D) grid.

The range image 45 is expressed as 2D coordinates (u, v). In the range image 45, u corresponds to the azimuth angle θ. v corresponds to the elevation angle φ.

The processor 11 allocates each lidar point to (e.g., 31, 33, or 35) to each cell 32, 34, or 36. For example, the lidar point 31 is allocated to the cell 32, and the lidar point 33 is allocated to the cell 34.

The spinning lidar 30 has the same angular resolution. Therefore, one lidar point (e.g., 31, 33, or 35) may be allocated to each cell (e.g., 32, 34, or 36), which allows clustering of the point clouds (e.g., 31, 33, and 35) in the range image 45 using a method according to the related art.

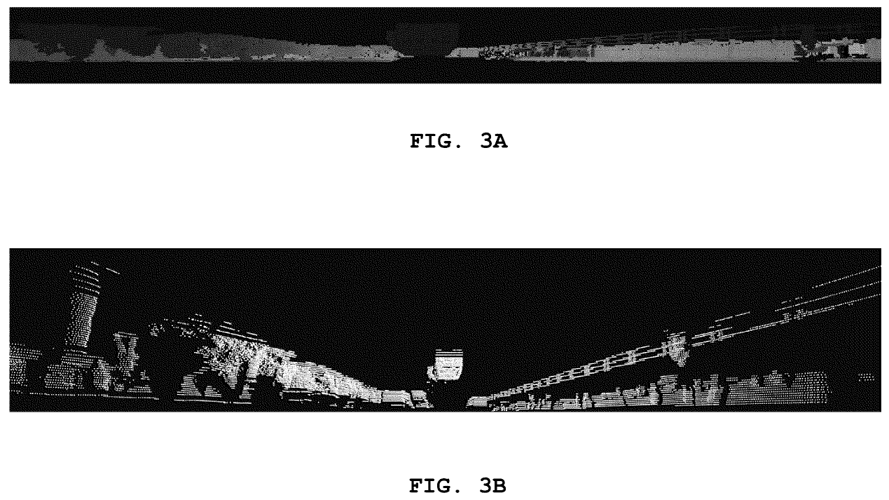

FIGS. 3A and 3B are a set of a 3D point cloud image and a range image.

FIG. 3A is a 3D point cloud image, and FIG. 3B is a range image.

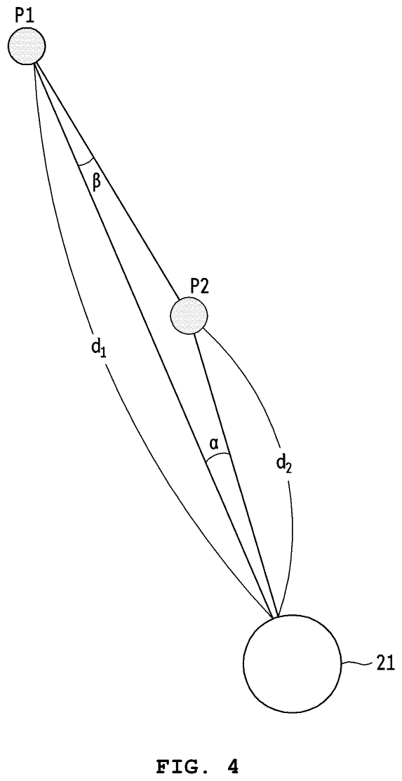

FIG. 4 is a conceptual diagram for determining whether lidar points included in a range image belong to the same cluster.

Referring to FIGS. 1 to 4, the processor 11 selects two lidar point (e.g., P1 and P2) from the lidar points (e.g., 31, 33, and 35) allocated to the cells (e.g., 32, 34, and 36).

The processor 11 determines whether the lidar points P1 and P2 are included in the same object (e.g., the vehicle 103 or the person 105) using lines d₁ and d₂ formed from the lidar sensor 21 to the two selected lidar points P1 and P2. The lines d₁ and d₂ are laser beams output from the lidar sensor 21. The lidar points P1 and P2 included in the same object represent that the lidar points P1 and P2 are included in the same cluster as the clustering result. In other words, the processor 11 determines how to cluster the lidar points P1 and P2. A cluster is a group of points close to a lidar point cloud.

The processor 11 determines whether the lidar points P1 and P2 are included in the same object (e.g., the vehicle 103 or the person 105) depending on an angle β between the line d₁ between the lidar sensor 21 and the first lidar point P1 and a line between the first lidar point P1 and the second lidar point P2. This may be defined as a clustering operation. In other words, it is determined whether the lidar points P1 and P2 are included in the same cluster. As a result of the clustering operation, a plurality of clusters may be generated. In the present specification, a cluster may be referred to as “group” or “segment.” A segment is a group of meaningful points that are smaller than the lidar points P1 and P2.

When the angle β is larger than a certain angle, the processor 11 determines that the lidar points P1 and P2 are included in the same object (e.g., the vehicle 103 or the person 105). The certain angle is randomly determined in advance by the processor 11. Here, the line d₁ between the lidar sensor 21 and the first lidar point P1 is to be longer than the line d₂ between the lidar sensor 21 and the second lidar point P2.

The angle β may be calculated as shown in equation 4 below.

$$β = atan ( \frac{{d}_{2} sin α}{{d}_{1} - {d}_{2} cos α} ) \qquad [ Equation 4 ]$$

An angle α is an angle between the line d₁ between the lidar sensor 21 and the first lidar point P1 and the line d₂ between the lidar sensor 21 and the second lidar point P2.

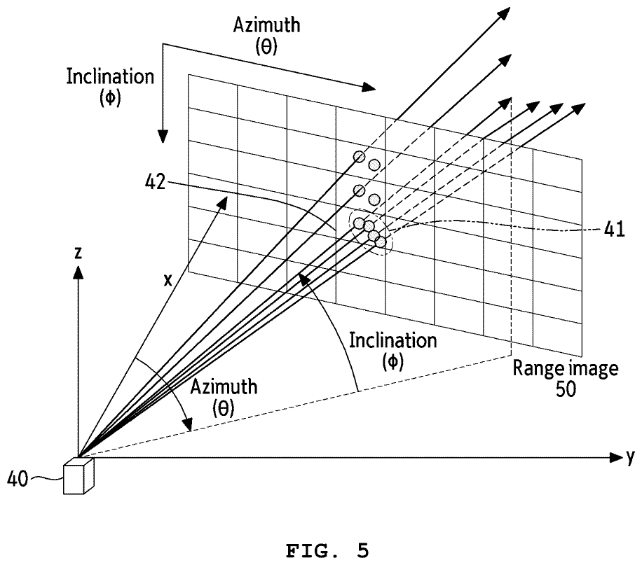

FIG. 5 is a conceptual diagram illustrating an operation of generating a range image using a solid-state lidar.

When the lidar sensor 21 shown in FIG. 1 is a solid-state lidar 40, a range image 50 is shown in FIG. 4. The processor 11 may generate the range image 50 using lidar point clouds 41 generated by the solid-state lidar 40 in a similar way to the method described in FIG. 2. The lidar point clouds 41 include a plurality of lidar points.

An example of the solid-state lidar 40 is an optical phased arrays (OPA) lidar, a micro-electro-mechanical systems (MEMS) lidar, a flash lidar, or the like.

With regard the OPA lidar, defects in manufacturing may cause variations in phase control precision. Also, regarding the OPA lidar, a beam angle may vary depending on wavelength and phase difference.

With regard to the MEMS lidar, an MEMS mirror has physical limitations on its movement speed and range, resulting in a variable spanning pattern. Also, regarding the MEMS lidar, scanning may not be uniform. A part of the scanning may be denser, and another part may be sparser.

With regard to the flash lidar, resolution may vary depending on pixel density of an array.

Due to these problems of the solid-state lidar 40, the solid-state lidar 40 has irregular angular resolution unlike the spinning lidar 30. In other words, the lidar point clouds 41 may not be allocated to different cells, and all the lidar point clouds 41 may be allocated to one cell 42, which is problematic.

Not only when the solid-state lidar 40 is used but also when two or more spinning lidars are used, the lidar point clouds 41 may not be allocated to different cells, and all the lidar point clouds 41 may be allocated to the single cell 42. The reason is that the lidar point clouds 41 may overlap.

When the lidar point clouds 41 are allocated to the single cell 42, the processor 11 cannot select one lidar point among the lidar point clouds 41 included in the single cell 42. Therefore, the processor 11 has a problem that it cannot determine whether lidar points belong to the same cluster using the above equation 4.

A method is proposed below to address issues caused by irregular angular resolution.

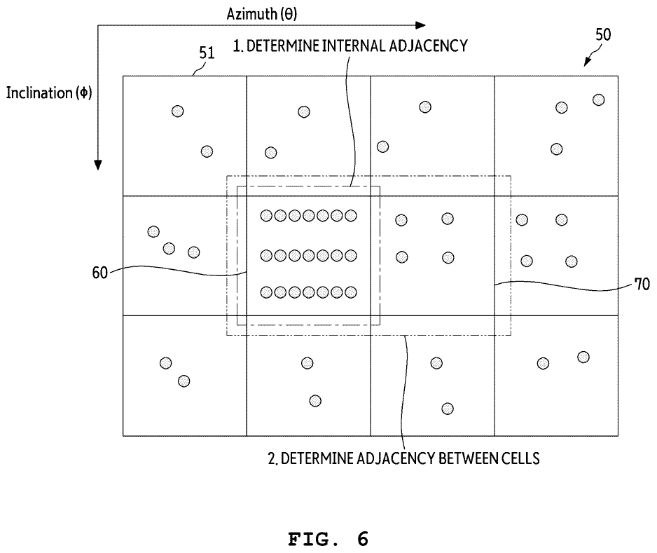

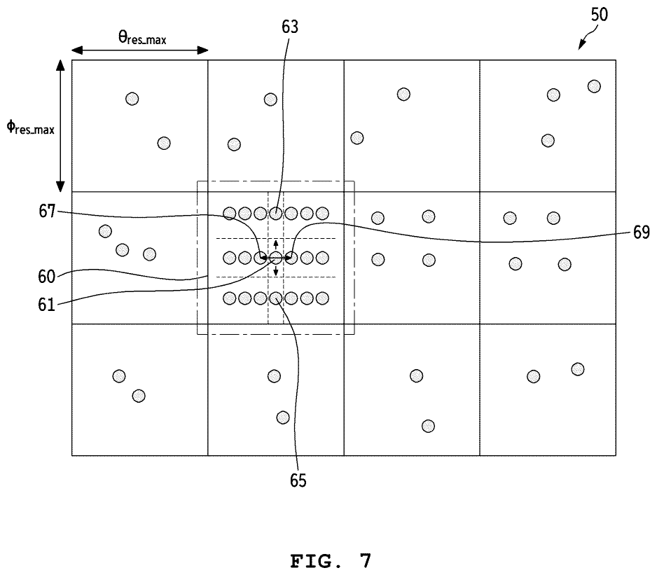

FIGS. 6 and 7 are range images illustrating a method of clustering lidar point clouds in a range image according to the present invention.

Referring to FIGS. 1 and 6, a range image 50 shown in FIG. 6 corresponds to the range image 50 generated by the solid-state lidar 40 shown in FIG. 5 or multiple lidars including two or more spinning lidars. The range image 50 is partitioned into a plurality of cells. In FIG. 6, the reference number “51” indicates one cell. In the range image 50 shown in FIG. 6, the x-axis represents an azimuth angle θ, and the y-axis represents an elevation angle φ.

The processor 11 determines the adjacency between lidar points within a cell 60. When a plurality of lidar points are included in the single cell 60, selecting two lidar points to determine whether the two lidar points in the single cell 60 are included in the same cluster is defined as determining the adjacency between lidar points within the cell 60.

Determining the adjacency between lidar points within the cell 60 will be described below with reference to FIG. 7.

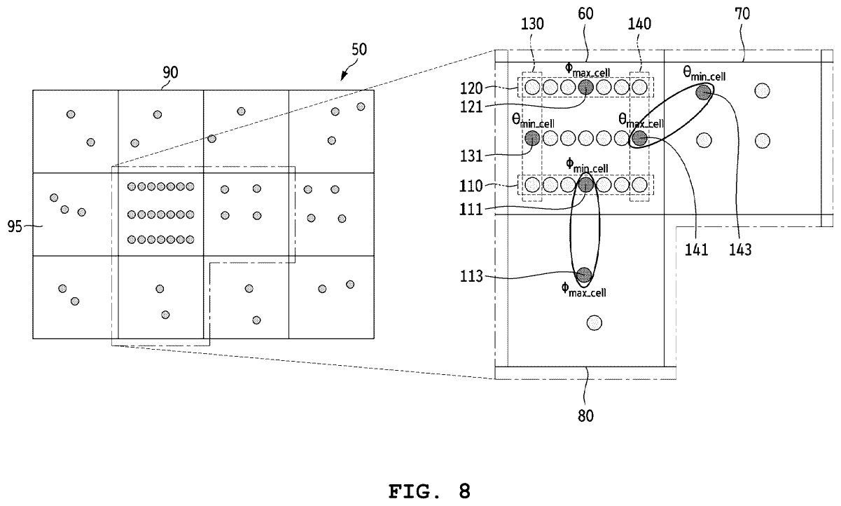

After the adjacency between lidar points within the cell 60 is determined, the processor 11 determines the adjacency between cells 60 and 70. When a plurality of lidar points are included in each of the cells 60 and 70, selecting two lidar points to determine whether the two lidar points included in the different cells 60 and 70 are included in the same cluster is defined as determining the adjacency between the cells 60 and 70. Determining the adjacency between the cells 60 and 70 will be described below with reference to FIG. 8.

Referring to FIGS. 1, 6, and 7, a method of determining the adjacency between lidar points within the cell 60 is disclosed. The processor 11 generates a range image 50 in accordance with the angular resolution of the lidar sensor 21. The range image 50 is partitioned into a plurality of cells in accordance with the maximum angular resolution (φ_{res_max}, θ_{res_max}) of the lidar sensor 21. The reference number “60” indicates one cell. One cell may be referred to as “grid.”

φ_{res_max} indicates the maximum elevation angle resolution of the lidar sensor 21, and θ_{res_max} indicates the maximum azimuth angle resolution of the lidar sensor 21.

The processor 11 randomly selects a first lidar point 61 included in a first cell (e.g., 60) among the plurality of cells of the range image 50. The processor 11 randomly selects the first cell (e.g., 60) in the range image partitioned into the plurality of cells and randomly selects the first lidar point 61 in the first cell.

The processor 11 selects lidar points 63, 65, 67, and 69 in first cell 60 to determine whether the lidar points 63, 65, 67, and 69 are included in the same cluster as the first lidar point 61.

Specifically, the processor 11 determines the selected lidar points 63, 65, 67, and 69 in accordance with phi value differences and theta value differences calculated between lidar points included in the first cell 60 and the first lidar point 61. A phi value difference is a difference between inclination angles φ, which correspond to the y axis, of two lidar points in the range image 50. A theta value difference is a difference between azimuth angles θ, which correspond to the x axis, of two lidar points in the range image 50.

The selected lidar points 63, 65, 67, and 69 include the lidar point 63 that has a smallest phi value difference Δφₘᵢₙ₁ among phi value differences Δφ calculated between the lidar points included in the first cell 60 and the first lidar point 61, the lidar point 65 that has a second smallest phi value difference Δφₘᵢₙ₂ among the phi value differences Δθ calculated between the lidar points included in the first cell 60 and the first lidar point 61, the lidar point 67 that has a smallest theta value difference Δθₘᵢₙ₁ among theta value differences 40 calculated between the lidar points included in the first cell 60 and the first lidar point 61, and the lidar point 69 that has a second smallest theta value difference Δθₘᵢₙ₂ among the theta value differences 40 calculated between the lidar points included in the first cell 60 and the first lidar point 61.

According to an exemplary embodiment, the processor 11 may determine the selected lidar points 63, 65, 67, and 69 using the following equation.

$$Val = \frac{\vert Δθ \vert}{{θ}_{resmin}} + \frac{\vert ΔΦ \vert}{{Φ}_{resmin}} \qquad [ Equation 5 ]$$

Val is a value, Δθ is a theta value difference calculated between the first lidar point 61 and any one of the lidar points included in the first cell 60, Δφ is a phi value difference calculated between the first lidar point 61 and any one of the lidar points included in the first cell 60, θᵣₑₛₘᵢₙ is the minimum azimuth angle resolution of the lidar sensor 21, and φᵣₑₛₘᵢₙ is the minimum elevation angle resolution of the lidar sensor 21.

The processor 11 may select the four lidar points 63, 65, 67, and 69 that have smallest values among values Val calculated for the lidar points included in the first cell 60 using the above equation 5.

The processor 11 determines whether the first lidar point 61 and the four selected lidar points 63, 65, 67, and 69 are included in the same cluster using the above equation 4. For example, the processor 11 determines whether the first lidar point 61 and the lidar point 63 are included in the same cluster using the above equation 4. Also, the processor 11 determines whether the first lidar point 61 and the other lidar point 65, 67, or 69 are included in the same cluster using the above equation 4.

After performing the clustering operation on the first lidar point 61 and the four selected lidar points 63, 65, 67, and 69, the processor 11 selects another lidar point included in the first cell (e.g., 60) and selects lidar points to determine whether the selected lidar points are included in the same cluster as the other lidar point.

The processor 11 determines whether the selected lidar points are included in the same cluster as the other lidar point included in the first cell (e.g., 60) using the above equation 4.

FIG. 8 is a range image illustrating a method of clustering lidar point clouds in a range image according to the present invention.

Referring to FIGS. 1, 6, and 8, a method of determining the adjacency between the cells 60 and 70 is disclosed.

The processor 11 randomly selects a second lidar point 111 among lidar points 110 with the smallest phi value in the first cell 60.

The processor 11 randomly selects a third lidar point 113 among lidar points with the largest phi value in a second cell 80 adjacent to the first cell 60. In FIG. 8, the reference number “φ_{max_cell}” is a lidar point with the largest phi value.

The processor 11 determines whether the second lidar point 111 and the third lidar point 113 are included in the same cluster using the above equation 4.

When an angle β calculated using the above equation 4 is larger than a certain angle, the processor 11 determines that the lidar points 111 and 113 are included in the same object (e.g., the vehicle 103 or the person 105). In other words, the processor 11 determines that the lidar points 111 and 113 are included in the same cluster, segment, or group.

When the angle β calculated using the above equation 4 is smaller than the certain angle, the processor 11 determines that the lidar points 111 and 113 are not included in the same object (e.g., the vehicle 103 or the person 105).

According to the exemplary embodiment, the processor 11 randomly selects a fourth lidar point 141 among lidar points 140 with the largest theta value in the first cell 60. In FIG. 8, the reference number “θ_{max_cell}” is lidar points 140 with the largest theta value.

The processor 11 randomly selects a fifth lidar point 143 among lidar points with the smallest theta value in a third cell 70 adjacent to the first cell 60. In FIG. 8, the reference number “θ_{min_cell}” is a lidar point with the smallest theta value.

The processor 11 determines whether the fourth lidar point 141 and the fifth lidar point 143 are included in the same cluster using the above equation 4.

According to the exemplary embodiment, the processor 11 may randomly select a sixth lidar point 121 among lidar points 120 with the largest phi value in the first cell 60. In FIG. 8, the reference number “φ_{max_cell}” is lidar points 120 with the largest phi value.

The processor 11 may randomly select a seventh lidar point (not shown) among lidar points with the smallest phi value in a fourth cell 90 adjacent to the first cell 60.

The processor 11 may determine whether the sixth lidar point 121 and the seventh lidar point (not shown) are included in the same cluster using the above equation 4.

According to the exemplary embodiment, the processor 11 may randomly select an eighth lidar point 131 among lidar points 130 with the smallest theta value in the first cell 60. In FIG. 8, the reference number “θ_{min_cell}” is lidar points 120 with the smallest theta value.

The processor 11 may randomly select a ninth lidar point (not shown) among lidar points with the largest theta value in a fifth cell 95 adjacent to the first cell 60.

The processor 11 may determine whether the eighth lidar point 131 and the ninth lidar point (not shown) are included in the same cluster using the above equation 4.

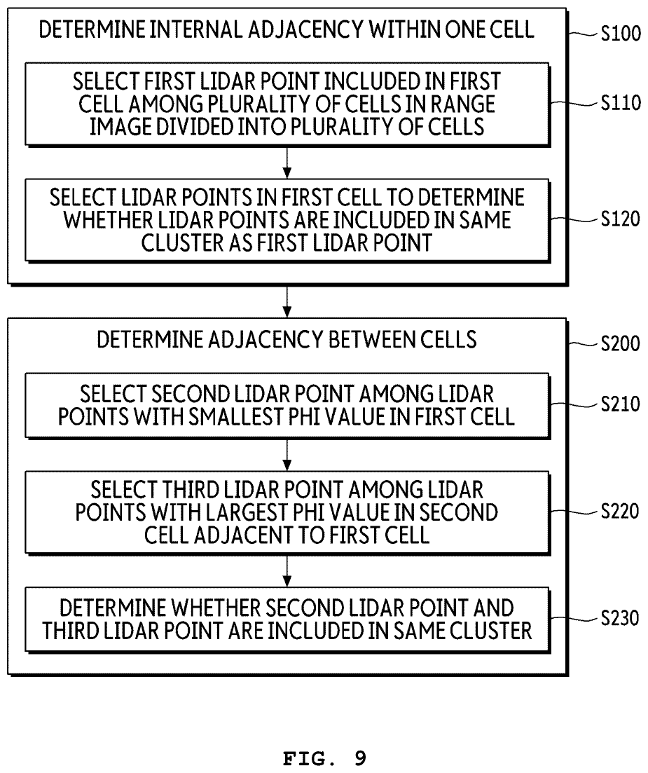

FIG. 9 is a flowchart illustrating a method of clustering lidar point clouds in a range image according to an exemplary embodiment of the present invention.

Referring to FIGS. 1 to 9, the processor 11 determines internal adjacency within one cell (e.g., 60) (S100). When a plurality of lidar points are included in the single cell 60, determining the adjacency between lidar points within the cell 60 may be defined as selecting two lidar points to determine whether the two lidar points in the single cell 60 are included in the same cluster.

Specifically, the processor 11 randomly selects the first lidar point 61 included in the first cell 60 among the plurality of cells of the range image 50 (S110).

The processor 11 selects the lidar points 63, 65, 67, and 69 in first cell 60 to determine whether the lidar points 63, 65, 67, and 69 are included in the same cluster as the first lidar point 61 (S120).

The lidar points 63, 65, 67, and 69 are selected in accordance with phi value differences and theta value differences calculated between lidar points included in the first cell 60 and the first lidar point 61.

After the adjacency between lidar points within the cell 60 is determined, the processor 11 determines the adjacency between the cells 60 and 70 (S200). When a plurality of lidar points are included in each of the cells 60 and 70, determining the adjacency between the cells 60 and 70 may be defined as selecting two lidar points to determine whether the lidar points included in the different cells 60 and 70 are included in the same cluster.

Specifically, the processor 11 randomly selects the second lidar point 111 among lidar points 110 with the smallest phi value in the first cell 60 (S210).

The processor 11 randomly selects the third lidar point 113 among lidar points with the largest phi value in the second cell 80 adjacent to the first cell 60 (S220).

The processor 11 determines whether the second lidar point 111 and the third lidar point 113 are included in the same cluster (S230).

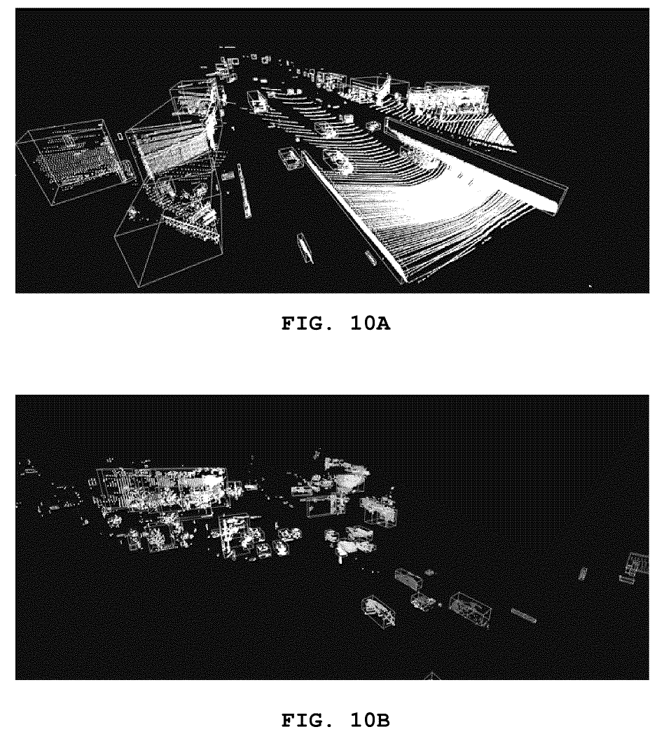

FIGS. 10A and 10B are a set of range images acquired using a method of clustering lidar point clouds in a range image according to an exemplary embodiment of the present invention.

FIG. 10A is a range image acquired using a method of clustering lidar point clouds in a range image according to an exemplary embodiment of the present invention on lidar points generated by a solid-state lidar.

FIG. 10B is a range image acquired using a method of clustering lidar point clouds in a range image according to an exemplary embodiment of the present invention on lidar points generated by multiple lidars including two or more spinning lidars.

With a method and device for clustering lidar point clouds in a range image according to embodiments of the present invention, it is possible to effectively cluster lidar point clouds even in a range image with irregular angular resolution by determining adjacency within a cell in the range image partitioned into a plurality of cells and determining the adjacency between cells.

Although the present invention has been described with reference to embodiments shown in the drawings, the embodiments are merely illustrative, and those of ordinary skill in the art should understand that various modifications and other equivalents can be made from the embodiments. Therefore, the genuine technical scope of the present invention should be determined by the technical spirit of the following claims.

What is claimed is:

1. A method of clustering lidar point clouds in a range image performed by a processor, the method comprising:
selecting a first lidar point included in a first cell among a plurality of cells in a range image partitioned into the plurality of cells; and
selecting lidar points in the first cell to determine whether the lidar points are included in the same cluster as the first lidar point.

2. The method of claim 1, further comprising:
selecting a second lidar point among lidar points with a smallest phi value in the first cell;
selecting a third lidar point among lidar points with a largest phi value in a second cell adjacent to the first cell; and
determining whether the second lidar point and the third lidar point are included in the same cluster.

3. The method of claim 1, further comprising:
selecting a fourth lidar point among lidar points with a largest theta value in the first cell;
selecting a fifth lidar point among lidar points with a smallest theta value in a third cell adjacent to the first cell; and
determining whether the fourth lidar point and the fifth lidar point are included in the same cluster.

4. The method of claim 1, wherein the selecting of the lidar points in the first cell to determine whether the lidar points are included in the same cluster as the first lidar point comprises determining the selected lidar points in accordance with phi value differences and theta value differences calculated between lidar points included in the first cell and the first lidar point.

5. The method of claim 1, wherein the selected lidar points include:
a lidar point with a smallest one of phi value differences calculated between lidar points included in the first cell and the first lidar point; and
a lidar point with the smallest one of theta value differences calculated between the lidar points included in the first cell and the first lidar point.

6. A computing device, comprising:
a processor configured to execute instructions to cluster lidar point clouds in a range image; and
a memory configured to store the instructions
wherein the instructions are implemented to perform the operations of:
selecting a first lidar point included in a first cell among a plurality of cells in a range image partitioned into the plurality of cells; and
selecting lidar points in the first cell to determine whether the lidar points are included in the same cluster as the first lidar point.

7. The computing device of claim 6, wherein the instructions are implemented to further perform the operations of:
selecting a second lidar point among lidar points with a smallest phi value in the first cell;
selecting a third lidar point among lidar points with a largest phi value in a second cell adjacent to the first cell; and
determining whether the second lidar point and the third lidar point are included in the same cluster.

8. The computing device of claim 6, wherein the instructions are implemented to further perform the operations of:
selecting a fourth lidar point among lidar points with a largest theta value in the first cell;
selecting a fifth lidar point among lidar points with a smallest theta value in a third cell adjacent to the first cell; and
determining whether the fourth lidar point and the fifth lidar point are included in the same cluster.

9. The computing device of claim 6, wherein the instructions implemented to perform the operation of selecting the lidar points are implemented to determine the lidar points in accordance with phi value differences and theta value differences calculated between lidar points included in the first cell and the first lidar point.

10. The computing device of claim 6, wherein the selected lidar points include:
a lidar point with a smallest one of phi value differences calculated between lidar points included in the first cell and the first lidar point; and
a lidar point with a smallest one of theta value differences calculated between the lidar points included in the first cell and the first lidar point.
